(19) United States
(12) Patent Application Publication
(10) Pub. No.: US 2008/0104030 A1
(43) Pub. Date: May 1, 2008

(54) System and Method for Providing Customized Information Based on User's Situation Information

(75) Inventors: Woo Il Choi, Seoul (KR); Jaebong Kim, Gyeonggi-do (KR)

Correspondence Address: Law Office of Mark J. Spolyar, 38 Fountain Street, San Francisco, CA, 94114, US

(73) Assignee: Yahoo! Inc., a Delaware Corporation

(21) Appl. No.: 11/608,580

(22) Filed: Dec. 8, 2006

(30) Foreign Application Priority Data
Oct. 27, 2006 (KR) 10-2006-104979

(51) Int. Cl. G06F 17/30

(52) U.S. Cl. 707/3

(57) ABSTRACT

An intelligent information providing system for searching and providing customized information relevant to physical situations of a user in wired/wireless networks is disclosed. The intelligent information providing system includes a recommendation database for storing recommendation information on applicable conditions representing a plurality of possible user situations, a personalization server for extracting recommendation information from the recommendation database based on a user's situation information, and a web server for receiving the recommendation information from the personalization server and providing it to the user. By employing the intelligent information providing system, it is possible to satisfy users' potential needs and provide customized advertisements based on such users' needs by providing relevant recommendation information to the users based on the users' situation information.

### TECHNICAL FIELD

The present disclosure relates to a system and method for providing customized information based on a user's situation information.

### BACKGROUND

As the Internet has become high integrated into everyday life, Internet websites have emerged as an attractive new medium to relay users to advertisers who want to advertise their products, services, and the like. Particularly, on the Internet, users are able to easily search for information on various products and services etc. through a search engine. The search engine provides advertisers with opportunities of satisfying Internet users' needs by exposing the advertisers' websites to the Internet users through keyword search or any other type of search services.

In general, a conventional search engine provides personalized information to users based on private information that the users inputted in advance through websites related to the search engine, or based on cookie information stored in a server or the users' terminals that are generated during a process of purchasing certain products through the websites. Further, the personalization information was search based on keywords included in search queries. However, such method cannot provide search results satisfying the users' potential needs that may not be recognized by the users. Further, the advertisers may not enjoy benefits of advertisements that are obtained by satisfying the users' potential needs, since such users' needs may not be expressed through a keyword search.

Meanwhile, there have been proposed personalized information providing methods, in which information on users' interests is recorded in a website when the users register their membership in the website, and then personalized information relevant to the users' interests is provided to the users open logging in the website, e.g., through notification means such as an e-mail and short message service. However, tis method had disadvantages that the users must become a member of the website, and then log in whenever they want to use or update the personalized information. Also, the users may have to check every e-mail or short message to find out necessary information or may be annoyed at e-mails or short messages received repeatedly in their mailboxes, which even appears on junk mail. In addition, since the information on the user's interests recorded at the time of becoming a member of the website cannot reflect a recent change of users' interests, the users may have to change their records on interested fields to obtain proper personalized information whenever their interests change.

Therefore, there is needed a method for providing personalized information and advertisements to users that satisfies the users' potential needs. Also, it is more desirable for such a method to produce personalized information reflecting current user's interests.

### SUMMARY

A feature of the present invention is to provide an intelligent system and method for providing personalized information that satisfies users' current potential needs based on the users' situation information.

Another feature of the invention is to provide an intelligent system and method for providing users with proper advertisements based on the users' situation information.

In accordance with one embodiment of the present invention, an intelligent information providing system is provided. The system includes a recommendation database for storing recommendation information for corresponding applicable conditions representing a plurality of situations, a personalization server for extracting recommendation information from the recommendation database based on users' situation information, and a web server for receiving the recommendation information from the personalization server, and providing it to the users.

In one embodiment, the personalization server may receive users' location information and weather information as the situation information from a location information server and a weather server.

Further, the system may further include a user log database for recording users' collective behaviors, a mining server for updating the recommendations information in the recommendation database by analyzing the users' collective behaviors in the user log database, and a user database for storing personal information of users who log into the system, and providing the personalization server with the personal information as the situation information.

In accordance with one embodiment of the present invention, there is provided a method for providing customized information in a search system, including collecting situation information of a user, searching recommendation information for the user by comparing the situation information with applicable conditions representing a plurality of situations, and providing the recommendation information to the user.

In one embodiment, the operation of collecting the situation information includes collecting the user's location information or collecting the user's location information based on cookies of the user's computer.

In the above embodiments, the recommendation information may include keywords that advertisers bid for based on a predetermined payment scheme including at least one of Cost-per-Click (CPC) and Cost-per-Action (CPA) methods. Further, matching scores may be assigned to the recommendation information, and a frequency of exposing the recommendation information may be determined based on the matching scores. The matching scores may be determined based on a degree of the situation information satisfying the applicable conditions or based on whether the recommendation information includes keywords that advertisers bid for based on a predetermined payment scheme including at least one of CPC and CPA methods

In accordance with another embodiment of the present invention, there is provided a method of updating recommendation information that is determined based on a user's situation information, including: analyzing the user's log data, extracting valid data for the user's situation information based on the user's log data, estimating a correlation of the valid data, and extracting updated applicable conditions and recommendation information based on the correlation of the valid data.

### BRIEF DESCRIPTION OF THE DRAWINGS

FIG. 1 shows a block diagram of an intelligent information providing system according to one embodiment of the present invention.

FIG. 2 is an example configuration of information stored in the recommendation database of FIG. 1.

FIG. 3 shows an example user log analysis algorithm performed by the mining server of FIG. 1.

FIG. 4 is a flow chart showing an example operation of the intelligent information providing system shown in FIG. 1.

FIGS. 5a and 5b show example web page showing recommendation information generated based on a user's situation information.

FIG. 6 illustrates an example computing system architecture, which may be used to implement the embodiments of the present invention.

### DESCRIPTION OF EXAMPLE EMBODIMENTS

Various embodiments of the present invention will be described in detail below with reference to the accompanying drawings. It will be apparent, however, that these embodiments may be practiced without some or all of these specific details. In other instances, well known process steps or elements have not been described in detail in order not to unnecessarily obscure the description of the invention.

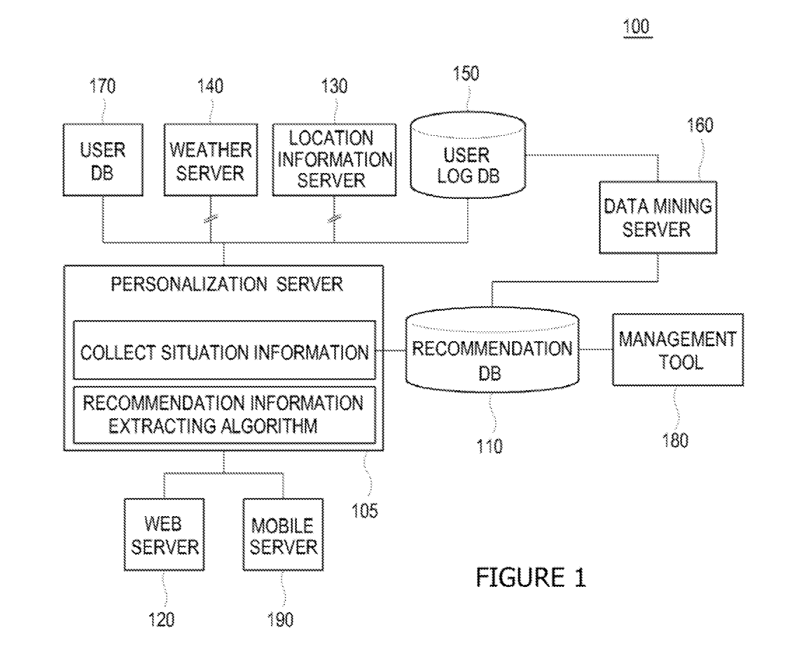

FIG. 1 shows a block diagram of an intelligent information providing system according to one embodiment of the present invention. The intelligent information providing system may be provided as integrated with a suitable search site.

The intelligent information providing system 100 includes a personalization server 105 for providing personalized information based on a user's situation information, a recommendation database 110 for storing recommendation information for applicable conditions estimated based on the situation information and providing it to the personalization server 105, and a web server 120 for receiving the recommendation information generated based on the user's situation information from the personalization server 105, and a web server 120 for receiving the recommendation information generated based on the user's situation information from the personalization server 105 and customize the recommendation information for providing it to the user. The personalization server 105 may receive the user's location information as the situation information from a location information server 130, and may receive weather information as the situation information that is extracted based on the user's location by a weather server 140.

The intelligent information providing system 100 may further include a user log database 150 for recording a history of user search queries, and a running server 160 for analyzing the users' collective behaviors and updating automatically the recommendation information stored on the recommendation database 110. The intelligent information providing system 100 may further include a user database 170 for storing and providing the users' private information as the situation information to the personalization server 105. The intelligent information providing system 100 may further include a management tool 180 for updating the recommendation information stored in the recommendation database 110, and a mobile server 190 for providing search results including the recommendation information received from the personalization server 105 to a mobile communication device.

Each element of the intelligent information providing system 100 will now be described in more detail with reference to the drawings.

In one embodiment, the personalization server 105 collects various situation information relevant to a user. For example, the personalization server 105 collects situation information on a user's access location and time. If a user logs in to the intelligent information providing system 100, the personalization server 105 may extract personal information such as the user's address interests and gender (male/female) from the user database 170. As such, the personalization server 105 collects users' various situation information, defines a number of applicable conditions which are categorized based on the user's situation information, and extracts recommendation information from the recommendation database 110 based on the applicable conditions. Any suitable algorithms for extracting recommendation information based on a user's situation information may be used in extracting the recommendation information from the recommendation database 110.

The location information server 130 provides the personalization server 105 with situation information on the user's location. The location information server 130 receives from the personalization server 105 an IP address of the user, the location information server 130 identifies the user's geographic location, and returns the user's geographic location as the situation information to the personalization server 105. The user's geographic location may include administrative district information such as “Gu” or “Dong” that is recognizable by the location information server 130. The location information server 130 may be a server of an Internet service provider, which is located outside the intelligent information providing system 100.

The user's location may also be extracted from address information that a user records in the user database 170 when the user logs in to the intelligent information providing system 100. Further, the user's location may be extracted from the user's cookies storing information on location searched recently or frequently by the user.

By employing the above-described configuration, a user may be provided with recommendation information relevant to his/her location without manual operations of inputting specific location name.

Meanwhile, the weather server 140 provides the personalization server 105 with situation information on the weather at a user's current location. Upon receiving the location information from the location information server 130, the personalization server 105 provides the location information to the weather server 140. Then, the weather server 140 returns weather information corresponding to the location information to the personalization server 105. The weather server 140 may be located outside the intelligent information providing system 100, e.g., at a national weather forecast institution or a private weather information providing company. For example, the situation information on the weather may include temperature, humidity, wind velocity, precipitation probability, ultraviolet index etc.

The user log database 150 stores information on user behavior. That is, the user database 150 stores log information, such as a user's IP address, access time, keywords included in search queries, resource locations clicked by the user, and the like. Such log information may be provided to the personalization server 105 as situation information.

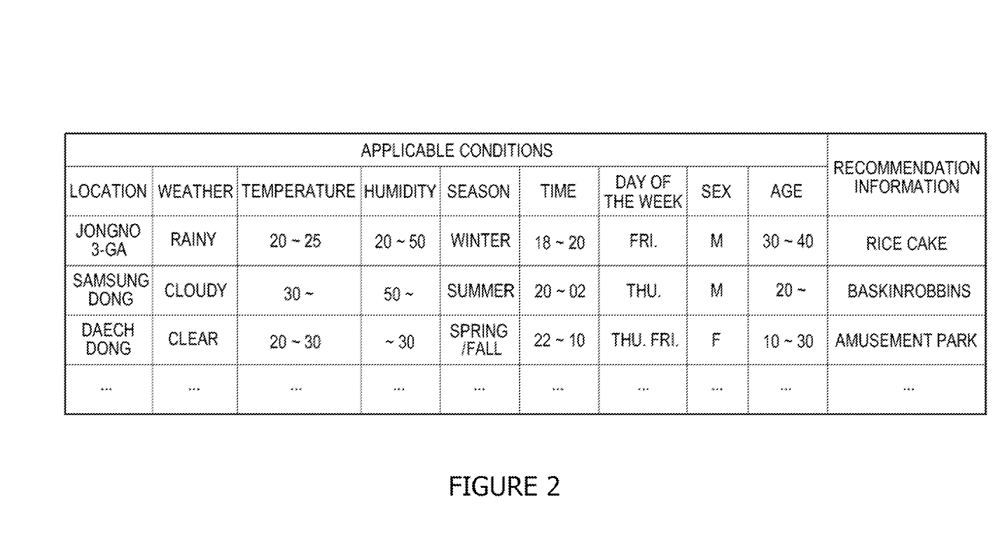

Further, the recommendation database 110 stores recommendation information generated based on the situation information. FIG. 2 depicts an example configuration of information stored in the recommendation database 110. For example, the recommendation database 110 stores information on a rice cake shop as recommendation information under the applicable conditions of rainy Friday night in winter. Also, the recommendation database 100 stores information on an ice cream shop (e.g., Baskin-Robbins) as recommendation information under the applicable conditions of Thursday evening at temperature of over 30° C. in summer. Such recommendation information is extracted by a recommendation information extraction algorithm running on the personalization server 105 based on the applicable conditions, which are determined based on the collected situation information maintained in the user behavior logs.

The contents of the recommendation database 110 may be updated periodically or as needed to correct errors or reflect a recent change of situation information. In one embodiment, the recommendation database 100 may be updated by the data mining server 160 or the management tool 180. The data mining server 160 executes a user log analysis algorithm to retrieve a set of valid data including information on user behavior from the user log database 150, and update the applicable conditions and the recommendation information stored in the recommendation database 110.

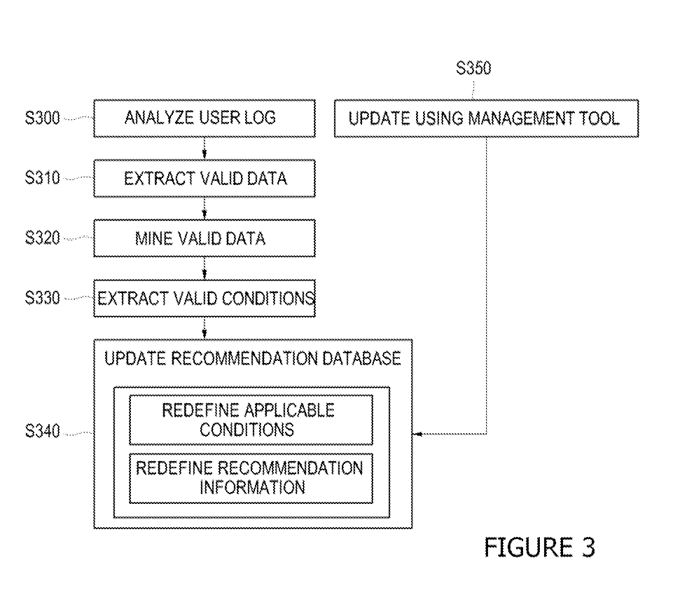

FIG. 3 illustrates a flowchart showing the operation of the user log analysis algorithm in accordance with one embodiment of the present invention. In the implementation shown, search logs are analyzed to generate recommendations and corresponding conditions. First, user log information stored in a user log database such as the user log database 150 (FIG. 1) is analyzed (S300). Then, valid data including information on user behavior are extracted from the user log information stored in the user log database (S310). In one embodiment, valid data such as a user's IP address, access time, keywords included in search queries and resource locators clicked by the user are extracted, which are used to update the recommendation information stored in a recommendation database such as the recommendation database 110 (FIG. 1). In some implementations, the process can also use information derived form this extracted information, such as the geographic locations corresponding to various IP addresses in the user behavior logs. Then, a data mining algorithm is executed to identify any correlations in the valid data between one or more search keywords (and/or resource locators clicked) and one or more observed conditions in the user logs (such as time, location, weather, and the like) (S320). For example, if valid data are extracted form a user behavior log such as inputting “rice cake” as search keywords and time/date of inputting such keywords, correlation of valid data on these two log behavior attributes can be estimated. That is, the data mining algorithm estimates correlation of valid data in case it is difficult to indicate its correlation in numerical representations. Thereafter, valid applicable conditions are extracted from the information on correlation of valid data (S330). The recommendation database is then updated by redefining the applicable conditions and the recommendation information stored therein based on the valid applicable conditions (S340). For example, if many users search for information on movie theaters Thursday evening in summer, the applicable conditions of “Thursday evening in summer” and corresponding recommendation information on movie theaters may be added to the recommendation database. In one embodiment, the recommendation database may be updated to delete recommendation information and relevant applicable conditions from the recommendation database, if such recommendation information has been rarely retrieved or selected irrespective of the relevant applicable conditions.

Now referring back to FIG. 1, the management tool 180 is used by a system administrator to update manually information stored in the recommendation database 110. Particularly, the management tool 180 is used to update the applicable conditions and corresponding recommendation information stored in the recommendation database 110, e.g., based on the system administrator's research results.

The user database 170 stores a user's personal information, e.g., that may be recorded when the user becomes a member of the search site operated by the intelligent information providing system 100.

In one embodiment, the web server 120 receives the recommendation information from the personalization server 105, which is generated based on a user's situation information as described above, and provides it to a user, e.g., by transforming the recommendation information to an appropriate format for use in the user's terminal. The recommendation information, for example, may be a list of recommendation keywords, which may be shown in a separate section in a web page. Further, the mobile server 190 provides a list of search results including the recommendation information to a mobile communication unit through a wireless network. In one embodiment, the wireless network, through which the mobile server 190 transmits data to the mobile communication unit, may be any type of communication networks such as CDMA, TDMA, GSM, Wibro, BlueTooth, and a combination of wireless/wired communication networks.

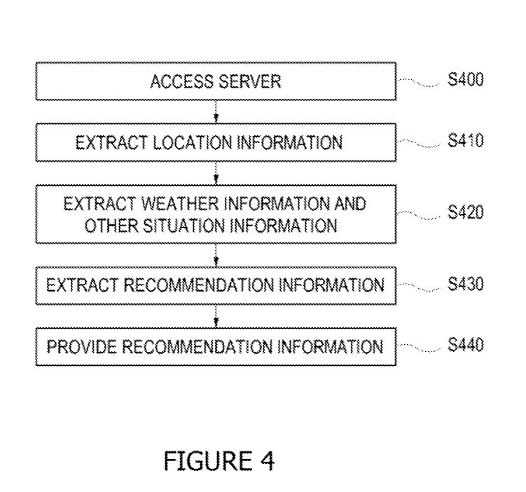

FIG. 4 is a flow chart showing the operation of the intelligent information providing system according to one embodiment.

First, if a user accesses an intelligent information providing system such as the system 100 (FIG. 1) through a wired network or a wireless network (S400), then the user's location information is extracted (S410). In one embodiment, the user's location information may be extracted as follows. Irrespective of whether the user logs in the system, a web server such as the web server 120 (FIG. 1) detects the user's IP address and transfer it to a location information server such as the location information server 130 (FIG. 1) through a personalization server such as the personalization server 105 (FIG. 1). The location information server returns the user's location information determined based on the user's IP address to the personalization server. Then, other situation information such as weather information is extracted (S420). For example, the personalization server extracts weather information from a weather server such as the weather server 140 (FIG. 1), and extracts other situation information from a user database and a user log database such as the user database 170 and the user log database 150 (FIG. 1).

Subsequently, the recommendation information is generated based on the extracted situation information (S430). In one embodiment, any suitable recommendation information extraction algorithm may be used for extracting the recommendation information based on the user's situation information. A personalization server such as the personalization server 100 (FIG. 1) extracts the recommendation information, which is defined in advance in a recommendation database such as the recommendation database 110 according to various applicable conditions as shown in FIG. 2. In one embodiment, the personalization server may transform a format of the recommendation information into a suitable format for use in the user's terminal, such that the user can browse the recommendation information (S440 and S450). The recommendation information may be given a matching score, which may determine an exposure frequency of the recommendation information, as described below. Further, the recommendation information may be provided to a user through a graphical representation such as an Avatar.

In the following, an example method of providing recommendation information to a user and a user interface therefore will be described in detail.

In one embodiment, recommendation information may be assigned a matching score. The matching score is determined differently depending on a degree of a user's situation information satisfying applicable conditions, which are defined in the recommendation database. For example, a matching score of 100 may be assigned to recommendation information if corresponding situation information satisfies all applicable conditions as defined in FIG. 2. In other instances, a matching score of 20 may be given to recommendation information if corresponding situation information satisfies only ⅓ of the applicable conditions. Further, an exposure frequency of the recommendation information may be determined based on its matching score. For example, assuming that updated recommendation information is provided to a user whenever a web page shown in the user's computer screen is refreshed, recommendation information with a matching score of 100 is exposed to the user 5 times more frequently than the one with a matching score of 30. As such, since recommendation information is presented to a user as being updated based on a change of the user's situation information and the matching score, the user can feel more interested in the recommendation information. Accordingly, this encourages the user to continue searching through the web site, which raises a click rate of recommendation information shown through the web page.

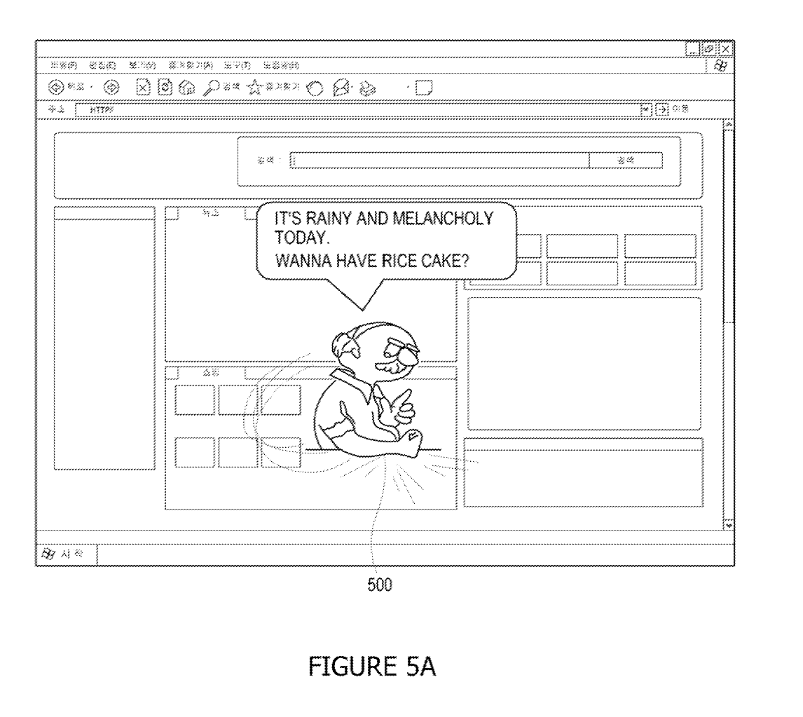

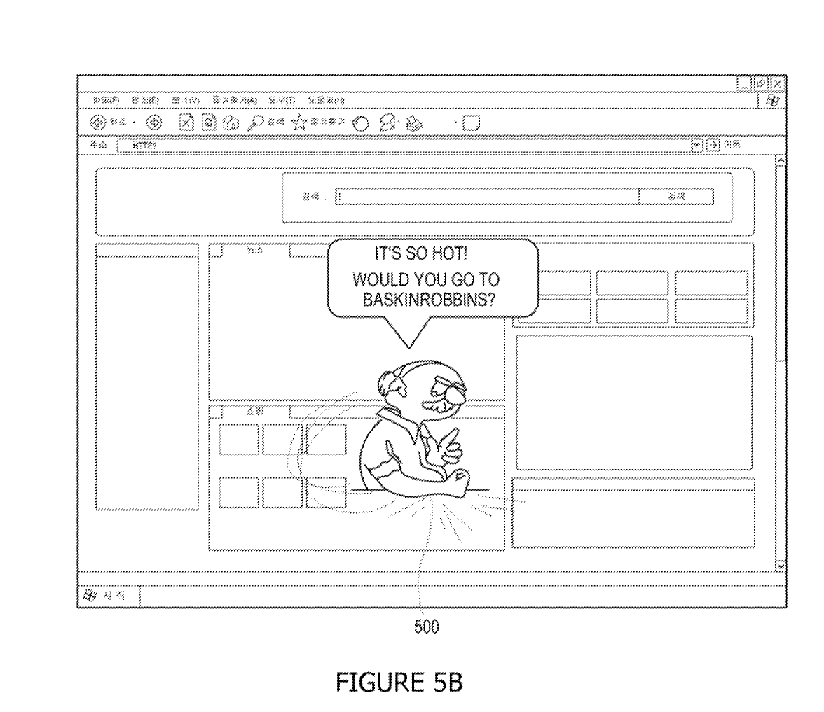

FIGS. 5a and 5b show example web pages, on which recommendation information is presented in accordance with one embodiment of the present invention. As show in FIGS. 5a and 5b, recommendation information may be presented to a user through an avatar, with which a user may feel more interested and comfortable. In FIG. 5a, an avatar 500 recommends “a rice cake shop” based on current situation information of a user, i.e., rainy and melancholy weather condition. Then, if a user clicks the avatar 500, a list of search results including resource locators linking to rice cake shops may be provided to the user, which is retrieved based on current situation information and/or applicable conditions. Further, as shown in FIG. 5b, a specific name of shop (e.g., Baskin-Robbins) may be provided as recommendation information to a user. Then, if the user clicks the avatar 500, this leads the user to access a web site of the recommended shop.

Alternatively, a list of recommendation information data may be provided to a user in a separate window such as a list box on a web page. In such a configuration, a frequency and/or order of recommendation information data in the list may be determined based on matching scores of the recommendation information data. That is, the higher the matching scores are, the more frequently corresponding recommendation information is ranked higher in the list. Further, any suitable user interfaces or methods for providing recommendation information may be applicable to the above embodiments.

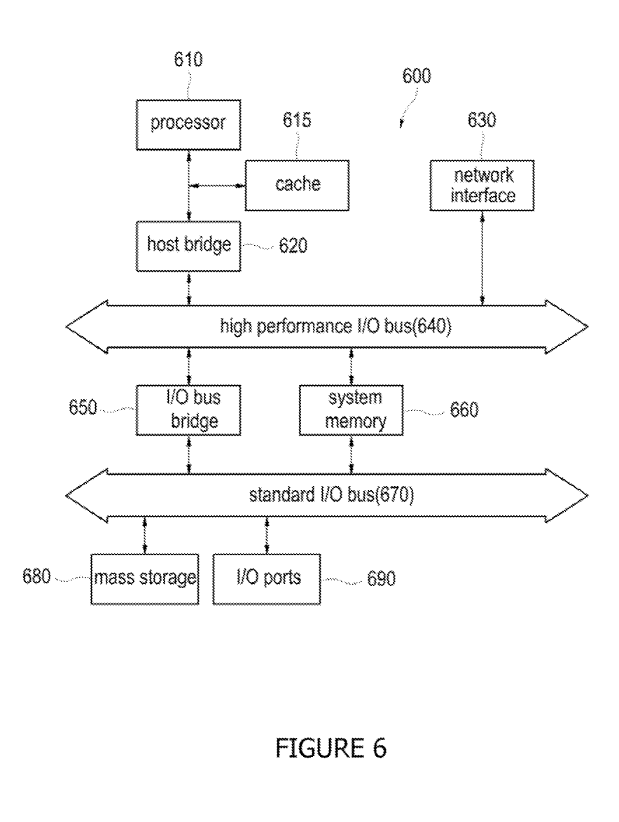

Although systems and methods have been described above with reference to specific embodiments, some or all of the elements or operations thereof may be implemented using a computer system having a general purpose hardware architecture. FIG. 6 illustrates an example computing system architecture, which may be used to implement one or more of the elements or operations described herein. In one implementation, hardware system 600 comprises a processor 610, a cache memory 615, and one or more software applications and drivers directed to the functions described herein.

Additionally, hardware system 600 includes a high performance input/output (I/O) bus 640 and a standard I/O bus 670. A host bridge 620 couples processor 610 to high performance I/O bus 640, whereas I/O bus bridge 650 couples the two buses 640 and 670 to each other. A system memory 660 and a network communication interface 630 are coupled to bus 640. Hardware system 600 may further include video memory (not shown) and a display device coupled to the video memory. Mass storage 630 and I/O ports 690 are coupled to bus 670. Hardware system 600 may optionally include a keyboard and pointing device, and a display device (not shown) coupled to bus 670. Collectively, these elements are intended to represent a broad category of computer hardware systems, including but not limited to general purpose computer systems based on the Pentium® processor manufactured by the Corporation of Santa Clara, Calif., as well as any other suitable processor.

The elements of hardware system 600 are described in greater detail below. In particular, network interface 630 provides communication between hardware system 600 and any of a wide range of networks, such as an Ethernet (e.g., IEEE 802.3) network, etc. In the case of the intelligent information providing system, the network interface 630 interfaces between the hardware system 600 and the network for allowing the hardware system 600 to manage those databases. Mass storage 630 provides permanent storage for the data and programming instructions to perform the above described functions implemented in the intelligent information providing system, whereas a system memory 660 (e.g., DRAM) provides temporary storage for the data and programming instructions when executed by processor 610. I/O ports 690 are one or more serial and/or parallel communication ports that provide communication between additional peripheral devices, which may be coupled to hardware system 600.

Hardware system 600 may include a variety of system architectures; and various components of hardware system 600 may be rearranged. For example, cache 615 may be on-chip with processor 610. Alternatively, cache 615 and processor 610 may be packed together as a “processor module,” with processor 610 being referred to as the “processor core.” Furthermore, certain implementations of the present invention may not require nor include all of the above components. For example, the peripheral devices shown coupled to standard I/O bus 670 may couple to high performance I/O bus 640. In addition, in some implementations only a single bus may exist, with the components of hardware system 600 being coupled to the single bus. Furthermore, hardware system 600 may include additional components, such as additional processors, storage devices, or memories. As discussed below, in one embodiment, the operations of the intelligent information providing system described here are implemented as a series of software routines run by hardware system described herein are implemented as a series of software routines run by hardware system 600. These software routines comprise a plurality or series of instructions to be executed by a processor in a hardware system, such as processor 610. Initially, the series of instructions are stored on a storage device, such as mass storage 630. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network communication interface 630. The instructions are copied form the storage device, such as mass storage 630, into memory 660 and then accessed and executed by processor 610.

An operating system manages and controls the operation of hardware system 600, including the input and output of data to and from software applications (not shown). The operating system provides an interface between the software applications being executed on the system and the hardware components of the system. According to one embodiment of the present invention, the operating system is the Windows® 95/98NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like.

By utilizing the foregoing embodiments, users' potential needs can be satisfied by providing recommendation information that is highly relevant to the users' current situation, even if the users do not log-in to a specific search site. By constructing a recommendation database for storing various applicable conditions and corresponding recommendation information, which is updated according to a change of users' log behaviors and a system administrator's research results, appropriate recommendation information can be extracted and provided based on the users' current situations.

Additionally, the efficiency of advertisements through CPC (Cost Per Click)/CPA (Cost Per Action) methods can be improved by estimating accurately the users' potential needs. Information on web sites, which advertisers bid for based on users' click rates, may be provided as recommendation information if such web sites satisfy applicable conditions for the users' current situation. For example, a higher matching score may be assigned to recommendation information if it is more relevant to keywords, for which many advertisers bid. As such, the advertisers can effectively advertise their web sites by increasing a probability of exposing their advertisements, and the search site manager can make more profits by encouraging the users to click links to recommendation information. Along similar lines, it is possible to estimate accurately users' potential needs and improve the efficiency of advertisements by providing relevant recommendation information to the users based on an analysis of the users' situation information or collective behavior patterns.

Furthermore, network traffic through a search site can be increased by transforming vague users' potential needs into more concrete recommendation information. Accordingly, the search site will gain reputation as media for advertisements.

In addition, the above embodiments may be utilized as a platform for providing recommendation information that leads to sales increases in multimedia streaming services such as VOD (Video on Demand) and AOD (Audio on Demand), Internet shopping mall services and the like. Information on products or services relevant to applicable conditions can be provided as recommendation information through a system administrator's manipulation or automatic update based on users' collective behavior patterns. For example, by employing the above embodiments, it is possible to recommend movies for certain weather conditions, music for specific time of the day, and products for a certain day of the week.

While the present invention and its various functional components have been described in particular embodiments, it should be appreciated that the present invention can be implemented in hardware, software, firmware, middleware or a combination thereof and utilized in systems, subsystems, components or sub-components thereof. When implemented in software, the elements of the present invention are the instructions/code segments to perform the necessary tasks. The program or code segments can be stored in a machine readable medium, such as a processor readable medium or a computer program product, or transmitted by a computer data signal embodied in a carrier wave, or a signal modulated by a carrier, over a transmission medium or communication link. The machine-readable medium or processor-readable medium may include any medium that can store or transfer information in a form readable and executable by a machine (e.g., a processor, a computer, etc.).

Further, while the present invention has been shown and described with respect to preferred embodiments, those skilled in the art will recognize that various changes and modifications may be made without departing from the spirit and scope of the invention as defined in the appended claims.

1. An information providing system comprising:
a recommendation database for storing recommendation information for corresponding applicable conditions representing a plurality of situations;
a personalization server for extracting recommendation information from the recommendation database based on users' situation information; and
a web server for receiving the recommendation information from the personalization server, and providing it to the users.

2. The system of claim 1, wherein the personalization server receives users' location information as the situation information from a location information server.

3. The system of claim 1, wherein the personalization server receives weather information corresponding to the users' location information as the situation information from a weather server.

4. The system of claim 1, further comprising:
a user log database for recording users' collective behaviors; and
a mining server for updating the recommendation information in the recommendation database by analyzing the users' collective behaviors in the user log database.

5. The system of claim 1, further comprising:
a user database for storing personal information of users who log in the system, and providing the personalization server with the personal information as the situation information.

6. The system of claim 1, further comprising:
a management tool for updating manually the recommendation information in the recommendation database.

7. The system of claim 1, wherein the personalization server collects users' location information based on cookies of the users' computers.

8. The system of claim 1, wherein the personalization server collects information on the users' access time to the system.

9. The system of claim 1, wherein the recommendation information includes keywords that advertisers bid for based on a predetermined payment scheme including at least one of CPC (Cost Per Click) and CPA (Cost Per Action) methods.

10. The system of claim 1, wherein the personalization server assign matching scores to the recommendation information and determines a frequency of exposing the recommendation information based on the matching scores.

11-12. (canceled)

13. A method for providing customized information in a search system, comprising:
collecting situation information of a user;
searching recommendation information for the user by comparing the situation information with applicable conditions representing a plurality of situations; and
providing the recommendation information to the user.

14. The method of claim 13, wherein the operation of collecting the situation information includes collecting the user's location information.

15. The method of claim 13, wherein the operation of collecting the situation information includes collecting the user's location information based on cookies of the user's computer.

16. The method of claim 13, wherein the operation of collecting the situation information includes collecting weather information based on the user's location.

17. The method of claim 13, wherein the operation of collecting the situation information includes collecting information on the user's access time to the system.

18. The method of claim 13, wherein the recommendation information includes keywords that advertisers bid for based on a predetermined payment scheme including at least one of CPC and CPA methods.

19. The method of claim 13, wherein the operation of providing the recommendation information to the user includes:
assigning matching scores to the recommendation information; and
determining a frequency of exposing the recommendation information based on the matching scores.

20. The method of claim 19, wherein the operation of assigning matching scores includes determining matching scores based on a degree of the situation information satisfying the applicable conditions.

21. The method of claim 19, wherein the operation of assigning matching scores includes determining the matching scores based on whether the recommendation information includes keywords that advertisers bid for based on a predetermined payment scheme including at least one of CPC and CPA methods.

22. A method of updating a recommendation database that is determined based on a user's situation information, comprising:
analyzing user log information stored in a user log database;
extracting valid data including information on a user's behavior from the user log information;
identifying a correlation in the valid data;
extracting valid applicable conditions based on the correlation in the valid data; and
redefining applicable conditions and recommendation information stored in the recommendation database based on the valid applicable conditions.

23. The method of claim 22, wherein the operation of identifying a correlation in the valid data includes identifying the correlation in the valid data between one or more search keywords and one or more observed conditions in the user log information.

24. The method of claim 22, wherein the operation of identifying a correlation in the valid data includes identifying a correlation in the valid data between one or more resource locators clicked by the user and one or more observed conditions in the user log information.

25. The method of claim 22, wherein the valid data include at least one of a user's IP address, access time, keywords included in search queries and resource locators clicked by the user.

26. Logic encoded in one or more tangible media for execution and when executed operable to cause the one or more processors to:
collect situation information of a user;
search recommendation information for the user by comparing the situation information with applicable conditions representing a plurality of situations; and
provide the recommendation information to the user.

27. Logic encoded in one or more tangible media for execution and when executed operable to cause the one or more processors to:
analyze user log information stored in a user log database;
extract valid data including information on a user's behavior from the user log information;
identify a correlation in the valid data;
extract valid applicable conditions based on the correlation in the valid data; and
redefine applicable conditions and recommendation information stored in the recommendation database based on the valid applicable conditions.
